(19) United States
(12) Patent Application Publication
(10) Pub. No.: US 2023/0238569 A1
(43) Pub. Date: Jul. 27, 2023

(54) LITHIUM-ION CELL WITH A HIGH SPECIFIC ENERGY DENSITY

(71) Applicant: VARTA Microbattery GmbH, Ellwangen Jagst (DE)

(72) Inventors: Edward Pytlik, Ellwangen (DE); David Ensling, Ellwangen (DE)

(21) Appl. No.: 18/009,349

(22) PCT Filed: May 31, 2021
(86) PCT No.: PCT/EP2021/064556

§ 371 Date: Dec. 9, 2022

(30) Foreign Application Priority Data
Jun. 9, 2020 (EP) 20179112.6

(51) Int. Cl. H01M 10/0525; H01M 50/46; H01M 4/04; H01M 4/587; H01M 4/75; H01M 4/505; H01M 4/525; H01M 10/0568; H01M 10/0569; H01M 4/36; H01M 4/38; H01M 4/485

(52) U.S. Cl. CPC H01M 10/0525; H01M 50/46; H01M 4/0404; H01M 4/587; H01M 4/75; H01M 4/505; H01M 4/525; H01M 10/0568; H01M 10/0569; H01M 4/364; H01M 4/386; H01M 4/485; H01M 2004/027

(57) ABSTRACT

A lithium-ion cell includes a ribbon-shaped electrode-separator assembly having an anode, a separator, and a cathode in a sequence anode/separator/cathode. The anode has a ribbon-shaped anode current collector having a first longitudinal edge, a second longitudinal edge, and two ends, wherein the anode current collector has a strip-shaped main region loaded with a layer of negative electrode material and a free edge strip extending along the first longitudinal edge that is not loaded with the electrode material. The cathode has a ribbon-shaped cathode current collector, wherein the cathode current collector has a strip-shaped main region loaded with a layer of positive electrode material and a free edge strip extending along the first longitudinal edge that is not loaded with the electrode material. The negative electrode material containing the at least one active material in a range of from 20 wt % to 90 wt %.

### CROSS REFERENCE TO RELATED APPLICATIONS

This application is a U.S. National Phase application under 35 U.S.C. § 371 of International Application No. PCT/EP2021/064556, filed on May 31, 2021, and claims benefit to European Patent Application No. EP 20179112.6, filed on Jun. 9, 2020. The International Application was published in German on Dec. 16, 2021 as WO 2021/249808 under PCT Article 21(2).

### FIELD

The disclosure relates to a lithium-ion cell comprising an electrode-separator assembly.

### BACKGROUND

Electrochemical cells can convert stored chemical energy into electrical energy by virtue of a redox-reaction. They generally comprise a positive and a negative electrode separated by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is ensured by an ion-conducting electrolyte.

If the discharge is reversible, i.e. if it is possible to reverse the conversion of chemical energy into electrical energy that took place during the discharge and thus to charge the cell again, this is said to be a secondary cell. The designation of the negative electrode as anode and the designation of the positive electrode as cathode, which is generally used for secondary cells, refers to the discharge function of the electrochemical cell.

The widely used secondary lithium-ion cells are based on the use of lithium, which can migrate back and forth between the electrodes of the cell in the form of ions. Lithium-ion cells are characterized by a comparatively high energy density. The negative electrode and the positive electrode of a lithium-ion cell are generally formed by so-called composite electrodes, which comprise electrochemically active components as well as electrochemically inactive components.

In principle, all materials that can absorb and release lithium ions can be used as electrochemically active components (active materials) for secondary lithium-ion cells. Carbon-based particles, such as graphitic carbon, are often used for the negative electrode. Other, non-graphitic carbon materials that are suitable for the intercalation of lithium can also be used. In addition, metallic and semi-metallic materials that are alloyable with lithium can also be used. For example, the elements tin, aluminum, antimony and silicon can form intermetallic phases with lithium. For example, lithium cobalt oxide (LiCoO₂), lithium manganese oxide (LiMn₂O₄), lithium titanate (Li₄Ti₅O₁₂) or lithium iron phosphate (LiFePO₄) or derivatives thereof can be used as active materials for the positive electrode. The electrochemically active materials are generally contained in particle form in the electrodes.

As electrochemically inactive components, the composite electrodes generally comprise a flat and/or strip-shaped current collector, for example a metallic foil, coated with an active material. For example, the current collector for the negative electrode (anode current collector) may be formed of copper or nickel, and the current collector for the positive electrode (cathode current collector) may be formed of aluminum, for example. Furthermore, the electrodes can comprise an electrode binder (e.g. polyvinylidene fluoride (PVDF) or another polymer, for example carboxymethyl cellulose). This ensures the mechanical stability of the electrodes and often the adhesion of the active material to the current collectors. Furthermore, the electrodes may contain conductivity-improving additives and other additives.

As electrolytes, lithium-ion cells generally comprise solutions of lithium salts such as lithium hexafluorophosphate (LiPF₆) in organic solvents (e.g., ethers and esters of carbonic acid).

During the manufacture of a lithium-ion cell, the composite electrodes are combined with one or more separators to form an assembly. In most cases, the electrodes and separators are joined together by lamination or bonding. The basic functionality of the cell can then be established by impregnating the composite with the electrolyte.

In many embodiments, the assembly is formed flat so that multiple assemblies can be stacked flat on top of each other. Frequently, however, the assembly is produced as a winding or processed into a winding.

Generally, the assembly, whether wound or not, comprises the sequence positive electrode/separator/negative electrode. Often, assemblies are manufactured as so-called bi-cells with the possible sequences negative electrode/separator/positive electrode/separator/negative electrode or positive electrode/separator/negative electrode/separator/positive electrode.

For applications in the automotive sector, for e-bikes or also for other applications with high energy requirements, such as in tools, lithium-ion cells with the highest possible energy density are needed that can simultaneously be loaded with high currents during charging and discharging. Such cells are described, for example, in WO 2017/215900 A1.

Cells for the applications mentioned are often designed as cylindrical round cells, for example with the form factor 21×70 (diameter*height in mm). Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

However, there are other factors to consider in the development of improved lithium-ion cells than just energy density. Extremely important parameters are also the internal resistance of the cells, which should be kept as low as possible to reduce power losses during charging and discharging, and the thermal connection of the electrodes, which can be essential for temperature regulation of the cell. These parameters are also very important for cylindrical round cells that contain a composite assembly in the form of a winding. During fast charging of cells, heat accumulation can occur in the cells due to power losses, which can lead to massive thermomechanical stresses and subsequently to deformation and damage of the cell structure. The risk is amplified if the electrical connection of the current collectors is made via separate electrical conductor tabs welded to the current collectors, which protrude axially from wound assemblies, since heating can occur locally at these conductor tabs under heavy loads during charging or discharging.

Very high energy densities can be achieved in particular when tin, aluminum, antimony and/or silicon are used as active materials in negative electrodes. Silicon has a maximum capacity of more than 3500 mAh/g. This is around ten times more than the specific capacity of graphite. In practice, however, the use of electrode materials with high proportions of the metallic active materials mentioned is associated with difficulties. Particles made of these materials are subject to comparatively strong volume changes during charging and discharging. This results in mechanical stresses and possibly also mechanical damage. For example, proportions of more than 10% silicon in negative electrodes have so far been difficult to control.

### SUMMARY

In an embodiment, the present disclosure provides a lithium-ion cell. The lithium-ion cell includes a ribbon-shaped electrode-separator assembly comprising an anode, a separator, and a cathode in a sequence anode/separator/cathode. The anode comprises a ribbon-shaped anode current collector having a first longitudinal edge, a second longitudinal edge, and two ends. The anode current collector has a strip-shaped main region loaded with a layer of negative electrode material and a free edge strip extending along the first longitudinal edge that is not loaded with the electrode material. The cathode comprises a ribbon-shaped cathode current collector having a first longitudinal edge, a second longitudinal edge, and two ends. The cathode current collector has a strip-shaped main region loaded with a layer of positive electrode material and a free edge strip extending along the first longitudinal edge that is not loaded with the electrode material. The lithium-ion cell further includes a housing that encloses the electrode-separator assembly and a contact sheet metal member in direct contact with a first respective longitudinal edge. The first respective longitudinal edge is the first longitudinal edge of the anode current collector or the first longitudinal edge of the cathode current collector. The contact sheet metal member is connected to the first respective longitudinal edge by welding. The electrode-separator assembly is in the form of: a winding comprising two terminal end faces or a stack comprising two or more electrode-separator sub-assemblies, the stack comprising two end sides. The anode and the cathode are formed and/or arranged relative to each other within the electrode-separator assembly such that the first longitudinal edge of the anode current collector protrudes from one of the terminal end faces of the winding or one of the end sides of the stack and the first longitudinal edge of the cathode current collector protrudes from another one of the terminal end faces of the winding or another one of the end sides of the stack. The negative electrode material comprises at least one of: silicon, aluminum, tin, antimony, and/or a compound or alloy thereof capable of reversibly incorporating and releasing lithium. The negative electrode material contains the at least one active material in a range of from 20 wt % to 90 wt %.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a top view of a current collector in an embodiment;

FIG. 2 is a sectional view of the current collector shown in FIG. 1;

FIG. 3 is a top view of an anode that can be processed into an electrode-separator assembly in the form of a winding;

FIG. 4 is a sectional view of the anode shown in FIG. 3;

FIG. 5 is a top view of an electrode-separator assembly fabricated using the anode shown in FIG. 3;

FIG. 6 is a sectional view of the electrode-separator assembly shown in FIG. 5;

FIG. 7 is a sectional view of a cylindrical round cell according to an embodiment;

FIG. 8 is a sectional view of a cylindrical round cell according to an embodiment;

FIG. 9 is a sectional view of a cylindrical round cell according to an embodiment;

FIG. 10 is a sectional view of a cylindrical round cell according to an embodiment;

FIG. 11 is a sectional view of a cylindrical round cell according to an embodiment; and

FIG. 12 is a schematic depiction of process steps for manufacturing the cell of FIG. 11.

### DETAILED DESCRIPTION

The present disclosure provides lithium-ion cells which are characterized by improved energy density compared to the prior art and which at the same time have excellent characteristics with respect to their internal resistance and passive heat dissipation capabilities.

According to a first aspect, a lithium-ion cell is characterized by the following features a. to j.:

a. The cell comprises an electrode-separator assembly having the sequence anode/separator/cathode, preferably a ribbon-shaped electrode-separator assembly having the sequence anode/separator/cathode.

b. The anode comprises an anode current collector having first and second edges, preferably a ribbon-shaped anode current collector having first and second longitudinal edges and two ends.

c. The anode current collector has a main region loaded with a layer of negative electrode material, preferably a strip-shaped main region loaded with a layer of the negative electrode material, and a free edge strip which extends along the first edge of the anode current collector, in particular along the first longitudinal edge of the anode current collector, and which is not loaded with the electrode material.

d. The cathode comprises a cathode current collector having first and second edges, preferably a ribbon-shaped cathode current collector having first and second longitudinal edges and two ends.

e. The cathode current collector has a main region loaded with a layer of positive electrode material, preferably a strip-shaped main region loaded with a layer of the positive electrode material, and a free edge strip which extends along the first edge of the cathode current collector, in particular along the first longitudinal edge of the cathode current collector, and which is not loaded with the electrode material.

f. The electrode-separator assembly is in the form of a winding with two terminal end faces or is part of a stack formed from two or more identical electrode-separator assemblies and also has two terminal faces.

g. The electrode-separator assembly, if necessary together with the other identical electrode-separator assembly or the other identical electrode-separator assemblies of the stack, is enclosed in a housing.

h. The anode and the cathode are formed and/or arranged relative to each other within the electrode-separator assembly such that the first edge or longitudinal edge of the anode current collector protrudes from one of the terminal faces or sides of the stack and the first edge or longitudinal edge of the cathode current collector protrudes from the other of the terminal faces or sides of the stack.

i. The cell has a contact sheet metal member, being in direct contact with one of the first edges or longitudinal edges, preferably longitudinally.

j. The contact sheet metal member is connected to this edge or longitudinal edge by welding.

Particularly preferably, the cell comprises two contact sheet metal members, one of which is in direct contact with the first edge or longitudinal edge of the anode current collector and the other of which is in direct contact with the first edge or longitudinal edge of the cathode current collector, the contact sheet metal members and the edges or longitudinal edges in contact therewith each being joined together by welding.

The current collectors have the function of electrically contacting electrochemically active components contained in the electrode material over an area as large as possible. Preferably, the current collectors are made of a metal or are at least metallized on the surface. Suitable metals for the anode current collector include copper or nickel or other electrically conductive materials, in particular copper and nickel alloys or nickel-coated metals. Stainless steel is also generally a possibility. Suitable metals for the cathode current collector include aluminum or other electrically conductive materials, in particular aluminum alloys.

Preferably, the anode current collector and/or the cathode current collector is each a metal foil having a thickness in the range of 4 μm to 30 μm, in particular a ribbon-shaped metal foil having a thickness in the range of 4 μm to 30 μm.

In addition to foils, however, other ribbon-shaped substrates such as metallic or metallized nonwovens or open-pore foams can be used as current collectors.

The current collectors are preferably loaded on both sides with the respective electrode material.

In the free edge strips, the metal of the respective current collector is free of the respective electrode material. Preferably, the metal of the respective current collector is uncovered in these areas so that it is available for electrical contacting, for example by welding.

However, in some embodiments, the metal of the respective current collector in the free edge strips may be coated with a support material that is more thermally resistant than the current collector coated therewith.

“Thermally more resistant” in this context is intended to mean that the support material retains a solid state at a temperature at which the metal of the current collector melts. It therefore either has a higher melting point than the metal or it sublimates or decomposes only at a temperature at which the metal has already melted.

Preferably, both the anode current collector and the cathode current collector each have a free edge strip along the first edge, preferably along the first longitudinal edge, which is not loaded with the respective electrode material. In a further development, it is preferred that both the at least one free edge strip of the anode current collector and the at least one free edge strip of the cathode current collector are coated with the support material. Particularly preferably, the same support material is used for each of the regions.

The support material which can be used can in principle be a metal or a metal alloy, provided that this or these has a higher melting point than the metal from which the surface coated with the support material consists of. In many embodiments, however, the lithium-ion cell has at least one of the immediately following additional features a. to d.:

a. The support material is a non-metallic material.

b. The support material is an electrically insulating material.

c. The non-metallic material is a ceramic material, a glass-ceramic material or a glass.

d. The ceramic material is aluminum oxide (Al₂O₃), titanium oxide (TiO₂), titanium nitride (TiN), titanium aluminum nitride (TiAlN), a silicon oxide, in particular silicon dioxide (SiO₂), or titanium carbonitride (TiCN).

The support material is preferably formed according to the immediately preceding feature b. and especially preferably according to the immediately preceding feature d.

The term non-metallic material comprises in particular plastics, glass and ceramic materials.

The term “electrically insulating material” is to be understood broadly in this context. In principle, it comprises any electrically insulating material, in particular also said plastics.

The term ceramic material is to be understood broadly in this context. In particular, this includes carbides, nitrides, oxides, silicides or mixtures and derivatives of these compounds.

By the term “glass-ceramic material” is meant in particular a material comprising crystalline particles embedded in an amorphous glass phase.

The term “glass” basically means any inorganic glass that meets the thermal stability criteria defined above and that is chemically stable to any electrolyte that may be contained in the cell.

Particularly preferably, the anode current collector consists of copper or a copper alloy while at the same time the cathode current collector consists of aluminum or an aluminum alloy and the support material is aluminum oxide or titanium oxide.

It may be further preferred that free edge strips of the anode and/or cathode current collector are coated with a strip of the support material.

The main regions, in particular the strip-shaped main regions of the anode current collector and cathode current collector, preferably extend parallel to the respective edges or longitudinal edges of the current collectors. Preferably, the strip-shaped main regions extend over at least 90%, preferably over at least 95%, of the areas of the anode current collector and the cathode current collector.

In some preferred embodiments, the support material is applied adjacent to the preferably strip-shaped main regions, but does not completely cover the free regions. For example, it is applied in the form of a strip or line along an edge of the anode and/or cathode current collector, in particular a longitudinal edge of the anode and/or cathode current collector, so that it only partially covers the respective edge strip. Directly along this edge or longitudinal edge, an elongated partial area of the free edge strip can remain uncovered.

Particularly preferably, the lithium-ion cell is a secondary lithium-ion cell.

Basically, all electrode materials known for secondary lithium-ion cells can be used for the anode and cathode of the cell.

Carbon-based particles such as graphitic carbon or non-graphitic carbon materials capable of intercalating lithium, preferably also in particle form, can be used as active materials in the negative electrode. Alternatively or additionally, lithium titanate (Li₄Ti₅O₁₂) or a derivative thereof may be included in the negative electrode, preferably also in particulate form.

In very preferred embodiments, however, the cell has, in addition to the above-mentioned obligatory features a. to j., immediately following feature k.:

k. The negative electrode material comprises as active material at least one material selected from the group consisting of silicon, aluminum, tin, antimony, and a compound or alloy of these materials capable of reversibly intercalating and de-intercalating lithium, in an amount of from 20 wt % to 90 wt %.

The weights given here refer to the dry mass of the negative electrode material, i.e. without electrolyte and without taking into account the weight of the anode current collector.

As mentioned at the beginning, tin, aluminum, antimony and silicon can form intermetallic phases with lithium. The capacity to absorb lithium exceeds that of graphite or comparable materials many times over, especially in the case of silicon.

Among the active materials mentioned, which are preferably also used in the form of particles, silicon is preferred. Cells whose negative electrode contains silicon as active material in a proportion of 20 wt. % to 90 wt. % are preferred.

Also some compounds of silicon, aluminum, tin, and/or antimony can reversibly deposit and remove lithium. For example, in some preferred embodiments, the silicon may be contained in oxidic form in the negative electrode. In these embodiments, it may be preferred that the negative electrode comprise silicon oxide in an amount ranging from 20 wt % to 90 wt %.

The design of the cell enables a significant advantage. As mentioned at the outset, electrodes in which the current collectors are electrically connected via the separate conductor tabs mentioned at the outset experience greater thermomechanical stresses during charging and discharging in the immediate vicinity of the conductor tabs than away from the conductor tabs. This difference is pronounced in the case of negative electrodes containing silicon, aluminum, tin and/or antimony as active material.

The electrical connection of the current collector(s) via the contact sheet metal members not only enables comparatively uniform and efficient heat dissipation in cells, but also distributes the thermomechanical stresses occurring during charging and discharging evenly over the winding. Surprisingly, this makes it possible to control very high proportions of silicon and/or tin and/or antimony in the negative electrode; at proportions >50%, damage as a result of the thermomechanical loads occurs comparatively rarely or not at all during charging and discharging. By elevating the proportion of silicon, for example, in the anode, the energy density of the cell can be greatly increased.

The skilled person understands that the tin, aluminum, silicon and antimony do not necessarily have to be metals in their purest form. For example, silicon particles may also contain traces or proportions of other elements, in particular other metals (apart from the lithium contained in any case as a function of the state of charge), for example in proportions of up to 40% by weight, in particular in proportions of up to 10% by weight. Thus, alloys of tin, aluminum, silicon and antimony can also be used.

In preferred embodiments, the cell has at least one of the immediately following features a. and b:

a. The negative electrode material further comprises, as negative active material, carbon-based particles capable of reversible lithium insertion and removal, such as graphitic carbon, in particular a mixture of the silicon and these carbon-based particles.

b. The carbon-based particles capable of intercalating lithium are contained in the electrode material in a proportion of from 5 wt. % to 75 wt. %, in particular in a proportion of from 15 wt. % to 45 wt. %.

In further preferred embodiments, the cell has at least one of the following features immediately below a. to c.:

a. The negative electrode material comprises an electrode binder and/or a conductive agent.

b. The electrode binder is contained in the negative electrode material in a proportion of 1 wt. % to 15 wt. %, in particular in a proportion of 1 wt. % to 5 wt. %.

c. The conductive agent is contained in the negative electrode material in a proportion of 0.1 wt. % to 15 wt. %, in particular in a proportion of 1 wt. % to 5 wt. %.

It is preferred that the immediately preceding features a. to c. are realized in combination with each other.

The active materials are preferably embedded in a matrix of the electrode binder, with adjacent particles in the matrix preferably being in direct contact with each other.

Conductive agents have the function of elevating the electrical conductivity of the electrodes. Common electrode binders are based on polyvinylidene fluoride (PVDF), polyacrylate or carboxymethyl cellulose, for example. Common conductive agents are carbon black and metal powder.

It is preferred that the positive electrode material comprises a PVDF binder and the negative electrode material comprises a polyacrylate binder, in particular lithium polyacrylic acid.

Suitable active materials for the positive electrode include lithium metal oxide compounds and lithium metal phosphate compounds such as LiCoO₂ and LiFePO₄.

Furthermore, lithium nickel manganese cobalt oxide (NMC) with the chemical formula LiNiₓMn_{y}Co_{z}O₂ (where x+y+z is typically 1) is well suited, Lithium manganese spinel (LMO) with the chemical formula LiMn₂O₄, or lithium nickel cobalt alumina (NCA) with the chemical formula LiNiₓCo_{y}Al_{z}O₂ (where x+y+z is typically 1). Derivatives thereof, for example lithium nickel manganese cobalt alumina (NMCA) with the chemical formula Li_{1.11}(Ni_{0.40}Mn_{0.39}Co_{0.16}Al_{0.05})_{0.89}O₂ or Li₁₊ₓ M-O compounds and/or mixtures of said materials can also be used.

The high silicon content in the anode requires a correspondingly high-capacity cathode in order to achieve a good cell balance. Therefore, NMC, NCA or NMCA are preferred.

In preferred embodiments, the cell has at least one of the immediately following features a. to e:

a. The positive electrode material comprises as active material at least one metal oxide compound capable of reversible lithium insertion and removal, preferably one of the above compounds, in particular NMC, NCA or NMCA.

b. The at least one oxidic compound is contained in the electrode material in a proportion of from 50% by weight to 99% by weight, in particular in a proportion of from 80% by weight to 99% by weight.

c. The positive electrode material also preferably comprises the electrode binder and/or the conductive agent.

d. The electrode binder is contained in the positive electrode material in a proportion of 1 wt. % to 15 wt. %, in particular in a proportion of 2 wt. % to 5 wt. %.

e. The conductive agent is contained in the positive electrode material in a proportion of 0.1 wt. % to 15 wt. %.

It is preferred that the immediately preceding features a. to e. are realized in combination with each other.

In the case of both the positive and negative electrodes, it is preferred that the percentages of each component contained in the electrode material add up to 100% by weight.

While high-capacity cathodes can store lithium reversibly in the range of 200-250 mAh/g, the theoretical capacity of silicon is about 3500 mAh/g. This leads to comparatively thick cathodes with high surface charge and very thin anodes with low surface charge. Since materials such as silicon react strongly to small voltage changes due to their very high capacitance, the anode current collector should be coated as homogeneously as possible. Even small differences in the loading of the current collector and/or the compaction of the electrode material can lead to strong local deviations in the electrode balance and/or stability.

For this reason, in preferred embodiments the cell has the immediately following feature:

a. The weight per unit area of the negative electrode (120) deviates from a mean value by a maximum of 2% per unit area of at least 10 cm².

The mean value is the quotient of the sum of at least 10 measurement results divided by the number of measurements performed.

Furthermore, the cell preferably comprises an electrolyte, for example based on at least one lithium salt such as lithium hexafluorophosphate (LiPF₆) dissolved in an organic solvent (e.g. in a mixture of organic carbonates).

In preferred embodiments, the cell has at least one of the immediately following features a. to d.:

a. The cell comprises an electrolyte comprising a mixture of tetrahydrofuran (THF) and 2-methyltetrahydrofuran (mTHF).

b. The volume ratio of THF:to mTHF in the mixture is in the range of 2:1 to 1:2, preferably it is 1:1.

c. The cell comprises an electrolyte comprising LiPF₆ as a conducting salt.

d. The conducting salt in a proportion of 1.5 to 2.5 M, in particular 2 M, contained in the electrolyte.

Particularly preferably, the electrolyte of the cell is characterized by all the above features a. to d.

In alternative preferred embodiments, the cell has at least one of the immediately following features a. to e:

a. The cell comprises an electrolyte comprising a mixture of fluoroethylene carbonate (FEC) and ethyl methyl carbonate (EMC).

b. The volume ratio of FEC:to EMC in the mixture is in the range of 1:7 to 5:7, preferably it is 3:7.

c. The cell comprises an electrolyte comprising LiPF₆ as a conducting salt.

d. The conducting salt is contained in the electrolyte at a concentration of 1.0 to 2.0 M, in particular 1.5 M.

e. The electrolyte comprises vinylene carbonate (VC), in particular in a proportion of 1 to 3% by weight.

Particularly preferably, the electrolyte of the cell is characterized by all the features a. to e. above.

The separator is, for example, an electrically insulating plastic film that can be penetrated by the electrolyte, for example because it has micropores. The foil can be formed, for example, from a polyolefin or from a polyether ketone. Nonwovens and fabrics made from such plastic materials can also be used as separators.

To improve cycling stability, the ratio of the capacitances of the anode to the cathode of the cell is preferably balanced so that the potential capacitance of the silicon is not fully utilized.

Particularly preferably, the cell according has the immediately following feature a:

e. The anode-to-cathode capacitances are balanced such that only 700-1500 mAh is reversibly used during operation per gram of electrode material of the negative electrode.

This measure allows volume changes to be significantly reduced.

Preferably, the ribbon-shaped anode and the ribbon-shaped cathode are offset from each other within the electrode-separator assembly to ensure that the first longitudinal edge of the anode current collector protrudes from one of the terminal end faces and the first longitudinal edge of the cathode current collector protrudes from the other of the terminal end faces.

In the manufacture of assemblies of electrodes and separators, care is usually taken to ensure that oppositely poled current collectors do not protrude from one side, as this can elevate the risk of short circuits. However, with the staggered arrangement of anode and cathode described above, the short-circuit hazard is minimized because the oppositely poled current collectors protrude from opposite end faces of the winding or sides of the stack.

The protrusion of the current collectors resulting from the staggered arrangement can be utilized by contacting them by means of an appropriate diverter, preferably over their entire length. The contact sheet metal member mentioned can serve as the diverter. Such electrical contacting significantly reduces the internal resistance within the cell. The arrangement described can thus absorb the occurrence of large currents very well. With minimized internal resistance, thermal losses at high currents are reduced. In addition, the dissipation of thermal energy from the wound electrode-separator assembly is favored. Under heavy loads, heating does not occur locally but is evenly distributed.

In addition to the elements mentioned, the lithium-ion cell expediently also comprises a housing consisting of two or more housing parts, which preferably encloses the electrode-separator assembly in the form of a winding in a gas-tight and/or liquid-tight manner.

When contact sheet metal members are used, it is generally necessary to connect the contact sheet metal members electrically to the housing or to electrical conductors that are led out of the housing. For example, the contact sheet metal members can be connected to the housing parts directly or via electrical conductors.

If the electrode-separator assembly is part of the stack of the two or more identical electrode-separator assemblies, the identical electrode-separator assemblies are arranged within the stack in such a way that the edges of their anode current collectors, optionally also the longitudinal edges of their anode current collectors, and the edges of their cathode current collectors, optionally also the longitudinal edges of their cathode current collectors, each protrude from the same page of the stack. Thus, all anode current collectors and all cathode current collectors can be electrically contacted simultaneously with the same contact sheet metal member in each case.

In preferred embodiments, the cell is characterized in that a portion of the housing serves as the contact sheet metal member and/or that the contact sheet metal member forms a portion of the housing enclosing the electrode-separator assembly.

These embodiments are advantageous. On the one hand, it is optimal with regard to heat dissipation. Heat generated within the winding can be dissipated directly to the housing via the edges, in particular the longitudinal edges. Secondly, the internal volume of a housing with given external dimensions can be utilized almost optimally in this way. Each separate contact sheet metal member and each separate electrical conductor for connecting the contact sheet metal members to the housing requires space inside the housing and adds to the weight of the cell. By eliminating such separate components, this space is available for active material. Thus, the energy density of cells can be further elevated.

In a first, preferred contacting variant, the cell has at least one of the immediately following features a. and b., preferably a combination of the two features:

a. The housing comprises a cup-shaped first housing part having a bottom and a circumferential side wall and an opening, and a second housing part closing the opening.

b. The contact sheet metal member is the bottom of the first housing part.

Preferably, the housing is cylindrical or prismatic in shape. Accordingly, the cup-shaped first housing part preferably has a circular or rectangular cross-section, and the second housing part and the bottom of the first housing part are preferably circular or rectangular in shape.

If the electrode-separator assembly is in the form of the winding with the two terminal end faces, the housing is preferably cylindrical. If, on the other hand, the electrode-separator assembly is part of the stack of two or more identical electrode-separator assemblies, the housing is preferably prismatic.

If the housing is cylindrical, it generally comprises a cylindrical housing shell as well as a circular upper part and a circular lower part, whereby in this variant the first housing part comprises the housing shell and the circular lower part while the second housing part corresponds to the circular upper part. The circular upper part and/or the circular lower part may serve as contact sheet metal members.

If the housing is prismatic, then the housing generally comprises several rectangular side walls as well as a polygonal, in particular rectangular upper part and a polygonal, in particular rectangular lower part, whereby in this variant the first housing part comprises the side walls and the polygonal lower part while the second housing part corresponds to the circular polygonal upper part. The upper part and/or the lower part may serve as contact sheet metal members.

Both the first and the second housing part preferably consist of an electrically conductive material, in particular a metallic material. The housing parts can, for example, consist of a nickel-plated sheet steel or alloyed or unalloyed aluminum independently of one another.

In a preferred further development of the first contacting variant, the cell has at least one of the immediately following features a. to e., in particular a combination of the features a. to e.:

a. The cell has a contact sheet metal member with which the first edge or longitudinal edge of the anode current collector is in direct contact, preferably longitudinally, and to which this edge or longitudinal edge is joined by welding.

b. The cell has a contact sheet metal member with which the first edge or longitudinal edge of the cathode current collector is in direct contact, preferably longitudinally, and to which this edge or longitudinal edge is connected by welding.

c. One of the contact sheet metal members is the bottom of the first housing part.

d. The other of the contact sheet metal members is connected to the second housing part via an electrical conductor.

e. The cell comprises a seal that electrically isolates the first and second housing parts from each other.

In this embodiment, conventional housing parts can be used to enclose the electrode-separator assembly. No space is wasted for electrical conductors, which are arranged between the bottom and the electrode-separator assembly. A separate contact sheet metal member is not required on the bottom side. To close the housing, the electrically insulating seal can be fitted to one edge of the second housing part. The assembly consisting of the second housing part and the seal can be inserted into the opening of the first housing part and mechanically fixed there, for example by means of a crimping process.

In a preferred embodiment of the first contacting variant, the second housing part can also serve as a contact sheet metal member. In this embodiment, the cell has at least one of the immediately following features, in particular a combination of the immediately following features a. to e.

a. The cell has a contact sheet metal member with which the first edge or longitudinal edge of the anode current collector is in direct contact, preferably longitudinally, and to which this edge or longitudinal edge is joined by welding.

b. The cell has a contact sheet metal member with which the first edge or longitudinal edge of the cathode current collector is in direct contact, preferably longitudinally, and to which this edge or longitudinal edge is connected by welding.

c. One of the contact sheet metal members is the bottom of the first housing part.

d. The other of the contact sheet metal members is the second housing part.

e. The cell comprises an electrical seal that electrically isolates the first and second housing parts from each other.

In this embodiment, electrical conductors are not required on either page of the electrode-separator assembly to connect the contact sheet metal members to housing parts. On one page, one of the contact sheet metal members also functions as a housing part, while on the other page a part of a housing serves as a contact sheet metal member. The space inside the housing can be used optimally.

In a further preferred further development of the first contacting variant, the cell has at least one of the immediately following features a. to e:

a. The cell has a contact sheet metal member with which the first edge or longitudinal edge of the anode current collector is in direct contact, preferably longitudinally, and to which this edge or longitudinal edge is joined by welding.

b. The cell has a contact sheet metal member with which the first edge or longitudinal edge of the cathode current collector is in direct contact, preferably longitudinally, and to which this edge or longitudinal edge is connected by welding.

c. One of the contact sheet metal members is the bottom of the first housing part.

d. The second housing part is welded into the opening of the first housing part and comprises a pole bushing, for example a pole stud surrounded by an electrical insulator, through which an electrical conductor is led out of the housing.

e. The other of the contact sheet metal members is electrically connected to this electrical conductor.

It is preferred that the immediately preceding features a. to e. are realized in combination with each other.

In this embodiment, the housing parts are welded together and thus electrically connected. For this reason, said pole bushing is required.

In a second preferred contacting variant, the cell has at least one of the immediately following features a. and b., and preferably a combination of the two features:

a. The housing comprises a tubular first housing part having two terminal openings, a second housing part closing one of the openings, and a third housing part closing the other of the openings.

b. The contact sheet metal member is the second housing part or the third housing part.

In this contacting variant, too, the housing of the cell is preferably cylindrical or prismatic. The tubular first housing part has a circular or rectangular cross-section and the second and third housing parts are preferably circular or rectangular.

If the housing is cylindrical, the first housing part is generally hollow cylindrical, while the second and third housing parts are circular and can serve as contact sheet metal members and simultaneously as a bottom and a lid, which can close the first housing part in a terminal manner.

If the housing is prismatic, then the first housing part generally comprises a plurality of rectangular side walls joined together by common edges, while the second and third housing parts are each polygonal, in particular rectangular. Both the second and third housing parts may serve as contact sheet metal members.

Both the first and the second housing part preferably consist of an electrically conductive material, in particular a metallic material. For example, the housing parts may consist of a nickel-plated steel sheet, stainless steel (for example of type 1.4303 or 1.4304), copper, nickel-plated copper or alloyed or unalloyed aluminum. It may also be preferred that housing parts electrically connected to the cathode consist of aluminum or an aluminum alloy, and housing parts electrically connected to the anode consist of copper or a copper alloy or nickel-plated copper.

A major advantage of this variant is that no cup-shaped housing parts to be produced by upstream forming and/or casting operations are required to form the housing. Instead, the tubular first housing part serves as the starting point.

In a preferred further development of the second variant, the cell has at least one of the immediately following features a. to e., in particular a combination of the immediately following features a. to e.:

a. The cell has a contact sheet metal member with which the first edge or longitudinal edge of the anode current collector is in direct contact, preferably longitudinally, and to which this edge or longitudinal edge is joined by welding.

b. The cell has a contact sheet metal member with which the first edge or longitudinal edge of the cathode current collector is in direct contact, preferably longitudinally, and to which this edge or longitudinal edge is connected by welding.

c. One of the contact sheet metal members is welded into one of the terminal openings of the first housing part and is the second housing part.

d. The third housing part is welded into the other of the terminal openings of the first housing part and comprises a pole bushing through which an electrical conductor is led out of the housing, for example a pole stud surrounded by an electrical insulator.

e. The other of the contact sheet metal members is electrically connected to this electrical conductor.

It is preferred that the immediately preceding features a. to e. are realized in combination with each other.

In a further preferred further development of the second variant, the cell has at least one of the immediately following features a. to d.:

a. The cell has a contact sheet metal member with which the first edge or longitudinal edge of the anode current collector is in direct contact, preferably longitudinally, and to which this edge or longitudinal edge is joined by welding.

b. The cell has a contact sheet metal member with which the first edge or longitudinal edge of the cathode current collector is in direct contact, preferably longitudinally, and to which this edge or longitudinal edge is connected by welding.

c. One of the contact sheet metal members is welded into one of the terminal openings of the first housing part and is the second housing part.

d. The other of the contact sheet metal members closes the other of the terminal openings of the first housing part as a third housing part and is insulated from the first housing part by means of a seal.

It is preferred that the immediately preceding features a. to d. are realized in combination with each other.

Both embodiments are characterized by that on one side of the housing a contact sheet metal member serves as a housing part and is connected to the first housing part by welding. On the other side, a contact sheet metal member can also serve as a housing part. However, this must then be electrically insulated from the first housing part. Alternatively, a pole bushing can be used here as well.

The pole bushings of cells comprise an electrical insulator which prevents electrical contact between the housing and the electrical conductor led out of the housing. The electrical insulator can be, for example, a glass or ceramic material or a plastic.

The electrode-separator assembly is preferably in the form of a cylindrical winding. Providing the electrodes in the form of such a winding allows advantageous use of space in cylindrical housings. The housing is therefore also cylindrical in preferred embodiments.

In other preferred embodiments, the electrode-separator assembly is in the form of a prismatic winding. Providing the electrodes in the form of such a winding allows advantageous use of space in prismatic housings. The housing is therefore also prismatic in preferred embodiments.

In addition, prismatic housings can be filled particularly well by prismatic stacks of the identical electrode-separator assemblies introduced above. For this purpose, the electrode-separator assemblies can preferably have a substantially rectangular basic shape.

It should be emphasized that all of the described embodiments in which a part of the housing serves as the contact sheet metal member and/or a contact sheet metal member forms part of the housing that encloses the electrode-separator assembly, in particular the first and second contacting variants, can also be implemented completely independently of feature k., supra (i.e. completely independently of the feature of: the negative electrode material comprises as active material at least one material selected from the group consisting of silicon, aluminum, tin, antimony, and a compound or alloy of these materials capable of reversibly incorporating and releasing lithium, in an amount of from 20 wt % to 90 wt %). The disclosure thus also comprises cells in which a part of the housing serves as the contact sheet metal member and/or the contact sheet metal member forms a part of the housing, but the anode does not necessarily have a proportion of 20% to 90% by weight of silicon, aluminum, tin and/or antimony as active material.

In preferred embodiments, the cell is characterized by at least one of the immediately following features a. to c.:

a. the strip-shaped main region of the current collector connected to the contact sheet metal member by welding, preferably the strip-shaped main region of the current collector connected to the contact sheet metal member by welding, has a plurality of apertures.

b. The apertures in the main area are round or square holes, especially punched or drilled holes.

c. The current collector connected to the contact sheet metal member by welding is perforated in the main area, in particular by round hole or slotted hole perforation.

The plurality of apertures results in a reduced volume and also reduced weight of the current collector. This makes it possible to introduce more active material into the cell and thus drastically increase the energy density of the cell. Energy density increases up to the double-digit percentage range can be achieved in this way.

In some preferred embodiments, the apertures are introduced into the strip-shaped main region by laser.

In principle, the geometry of the apertures is not essential. What is important is that as a result of the insertion of the apertures, the mass of the current collector is reduced and there is more space for active material, since the apertures can be filled with the active material.

On the other hand, it can be very advantageous to ensure that the maximum diameter of the apertures is not too large when inserting them. Preferably, the apertures should not be more than twice the thickness of the layer of electrode material on the respective current collector.

In preferred embodiments, the cell is characterized by the immediately following feature a.:

a. The apertures in the current collector, especially in the main region, have diameters in the range of 1 μm to 3000 μm.

Within this preferred range, diameters in the range from 10 μm to 2000 μm, preferably from 10 μm to 1000 μm, especially from 50 μm to 250 μm, are further preferred.

Particularly preferably, the cell has at least one of the immediately following features a. and b.

a. The contact sheet metal member joined to the current collector by welding has a lower weight per unit area than the free edge strip of the same current collector, at least in a partial section of the main area.

b. The current collector connected to the contact sheet metal member by welding has no or fewer apertures per unit area in the free edge strip than in the main area.

It is preferred that the immediately preceding features a. and b. are realized in combination with each other.

The free edge strips of the anode and cathode current collector bound the main area towards the first edges or the first longitudinal edges. Preferably, both the anode and cathode current collectors comprise free edge strips along both of their edges, in particular along both of their longitudinal edges.

The apertures characterize the main area. In other words, the boundary between the main area and the free edge strip(s) corresponds to a transition between areas with and without apertures.

The apertures are preferably distributed substantially evenly over the main area.

In further preferred embodiments, the cell has at least one of the immediately following features a. to c.:

a. The weight per unit area of the current collector in the main area is reduced by 5% to 80% compared to the weight per unit area of the current collector in the free edge strip.

b. The current collector has a hole area in the range of 5% to 80% in the main area.

c. The current collector has a tensile strength of 20 N/mm² to 250 N/mm² in the main area.

The hole area, often referred to as the free cross-section, can be determined according to ISO 7806-1983. The tensile strength of the current collector in the main area is reduced compared to current collectors without the apertures. Its determination can be done according to DIN EN ISO 527 part 3.

It is preferred that the anode current collector and the cathode current collector are identical or similar in terms of apertures. The respective achievable energy density improvements add up. In preferred embodiments, the cell therefore has at least one of the immediately following features a. to c.:

a. The anode current collector main region and the cathode current collector main region, preferably the strip-shaped anode current collector main region and the strip-shaped cathode current collector main region, are both characterized by a plurality of the apertures.

b. The cell comprises the contact sheet metal member resting on one of the first edges or longitudinal edges as the first contact sheet metal member, and further comprises a second contact sheet metal member resting on the other of the first edges or longitudinal edges.

c. The second contact sheet metal member is connected to this other edge or longitudinal edge by welding.

It is preferred that the immediately preceding features a. to c. are realized in combination with each other. However, features b. and c. can also be implemented in combination without feature a.

The preferred embodiments of the current collector provided with the apertures described above are independently applicable to the anode current collector and the cathode current collector.

The use of perforated current collectors or those otherwise provided with a plurality of apertures has not yet been seriously considered for lithium-ion cells, since it is very difficult to contact such current collectors electrically. As mentioned at the beginning, the electrical connection of the current collectors is often made via separate electrical conductor tabs. However, reliable welding of these conductor tabs to perforated current collectors in industrial mass production processes is difficult to realize without an acceptable error rate.

This problem can be solved by welding the current collector edges to the contact sheet metal members as described. It is therefore possible to completely dispense with separate conductor tabs, thus enabling the use of current collectors with a low material content and provided with apertures. In particular, in embodiments in which the free edge strips of the current collectors are not provided with apertures, welding can be performed reliably with exceptionally low reject rates.

If very thin metal foils are used as current collectors, the edges of the current collectors, in particular the longitudinal edges of the current collectors, can be extremely sensitive mechanically and can be unintentionally pressed down far or melted down during welding with contact sheet metal members. Furthermore, melting of separators of the electrode-separator assembly can occur during welding of the contact sheet metal members. The support layer described above counteracts this.

It should be emphasized that all the described embodiments in which the preferably strip-shaped main region of the current collector connected to the contact sheet metal member by welding has a plurality of apertures can also be realized completely independently of feature k., supra (i.e. completely independently of the feature: the negative electrode material (123) comprises as active material at least one material selected from the group consisting of silicon, aluminum, tin, antimony, and a compound or alloy of these materials capable of reversibly incorporating and releasing lithium, in an amount of from 20 wt % to 90 wt %). The disclosure thus also comprises cells in which the strip-shaped main region of the current collector connected to the contact sheet metal member by welding has a plurality of apertures, but the anode does not necessarily have a proportion of 20% to 90% by weight of silicon, aluminum, tin and/or antimony as active material.

The concept of welding the edges of current collectors with contact sheet metal members is already known from WO 2017/215900 A1 or JP 2004-119330 A. The use of contact sheet metal members enables particularly high current carrying capacities and low internal resistance. With regard to methods for electrically connecting contact sheet metal members to the edges of current collectors, full reference is therefore made to the contents of WO 2017/215900 A1 and JP 2004-119330 A.

The contact sheet metal members may also be referred to as contact plates. In preferred embodiments, they are plate-shaped.

In some preferred embodiments, the cell has at least one of the immediately following features a. and b.:

a. Metal plates with a thickness in the range from 50 μm to 600 μm, preferably 150-350 μm, are used as contact sheet metal members, in particular as contact plates.

b. The contact sheet metal members, in particular the contact plates, consist of alloyed or unalloyed aluminum, titanium, nickel or copper, but also, if necessary, of stainless steel (for example of type 1.4303 or 1.4304) or nickel-plated steel.

The thicknesses indicated are preferred both in the cases described where a contact sheet metal member is part of the housing and in cases where a contact sheet metal member does not serve as part of the housing.

In particular, in embodiments in which a contact sheet metal member, especially a contact plate, does not serve as part of the housing, it may have at least one slot and/or at least one perforation. These have the function of counteracting deformation of the sheet metal parts, in particular the plates, during the production of the welded joint.

In particular, in embodiments in which a contact sheet metal member, especially a contact plate, serves as part of the housing, slots and perforations are preferably dispensed with. However, such a contact sheet metal member, in particular such a contact plate, may have an aperture, in particular a hole in a central region.

In cases where the housing is cylindrical, contact sheet metal members, in particular contact plates, are preferably used which have the shape of a disk, in particular the shape of a circular or at least approximately circular disk. They then have an outer circular or at least approximately circular disk edge. In this context, an approximately circular disc is to be understood in particular as a disc which has the shape of a circle with at least one cut off circular segment, preferably with two to four cut off circular segments.

In cases where the housing is cylindrical, contact sheet metal members, in particular contact plates, are preferably used which have a rectangular basic shape.

In preferred embodiments, the anode current collector and the contact plate welded thereto, in particular the contact plate welded thereto, both consist of the same material. This is preferably selected from the group comprising copper, nickel, titanium, nickel-plated steel and stainless steel.

In further preferred embodiments, the cathode current collector and the contact plate welded thereto, in particular the contact plate welded thereto, both consist of the same material. This is preferably selected from the group comprising alloyed or unalloyed aluminum, titanium and stainless steel (e.g. of type 1.4404).

As mentioned above, the cell has a contact sheet metal member with which one of the first edges, in particular one of the first longitudinal edges, is in direct contact with, preferably longitudinally. This may result in a line-shaped contact zone.

In possible preferred developments, the cell has at least one of the immediately following features a. to c.:

a. The first edge of the anode current collector, in particular the first longitudinal edge of the anode current collector, is in direct contact with a contact sheet metal member, preferably longitudinally, and is connected to this contact sheet metal member by welding, wherein a line-shaped contact zone exists between the edge or longitudinal edge and the contact sheet metal member.

b. The first edge of the cathode current collector, in particular the first longitudinal edge of the cathode current collector, is in direct contact with a contact sheet metal member, preferably longitudinally, and is connected to this contact sheet metal member by welding, wherein a line-shaped contact zone exists between the edge or longitudinal edge and the contact sheet metal member.

c. The first edge or longitudinal edge of the anode current collector and/or the first edge or longitudinal edge of the cathode current collector comprises one or more sections, each of which is continuously connected to the respective contact sheet metal member along its entire length by a weld seam.

The immediately preceding features a. and b. can be implemented both independently of each other and in combination. Preferably, however, features a. and b. are implemented in both cases in combination with the immediately preceding feature c.

Via the contact sheet metal members, it is possible to electrically contact the current collectors and thus also the associated electrodes over their entire length. This significantly reduces the internal resistance within the cell. The arrangement described can thus excellently absorb the occurrence of large currents. With minimized internal resistance, thermal losses at high currents are reduced. In addition, the dissipation of thermal energy from the electrode-separator assembly is favored.

There are several ways in which the contact sheet metal members can be connected to the edges, especially the longitudinal edges.

The contact sheet metal members may be joined to the edges or longitudinal edges along the line-shaped contact zones by at least one weld seam. The edges or longitudinal edges may thus comprise one or more sections, each of which is continuously connected to the contact sheet metal member or contact sheet metal members over its entire length by a weld seam. Particularly preferably, these sections have a minimum length of 5 mm, preferably of 10 mm, especially preferably of 20 mm.

In one possible further development, the section or sections connected continuously to the contact sheet metal member over their entire length extend over at least 25%, preferably over at least 50%, preferably over at least 75%, of the total length of the respective edge or longitudinal edge.

In some preferred embodiments, the edges or longitudinal edges are continuously welded to the contact sheet metal member along their entire length.

In further possible embodiments, the contact sheet metal members are connected to the respective edge or longitudinal edge via a plurality or plurality of welding spots.

If the electrode-separator assembly is in the form of a spiral winding, the longitudinal edges of the anode current collector and the cathode current collector protruding from the terminal end faces of the winding generally also have a spiral geometry. The same then applies to the line-shaped contact zone along which the contact sheet metal members are welded to the respective longitudinal edge.

If the electrode-separator assembly is part of the stack of the two or more identical electrode-separator assemblies, the edges of the anode current collector and the cathode current collector protruding from the terminal pages of the stack often have a linear geometry. The same then applies to the line-shaped contact zone along which the contact sheet metal members are welded to the respective edge.

In further possible preferred further developments, the cell has at least one of the immediately following features a. to c.:

a. The separator is a preferably ribbon-shaped plastic substrate having a thickness in the range of 5 μm to 50 μm, preferably in the range of 7 μm to 12 μm, and having first and second longitudinal edges and two ends.

b. The edges of the separator, in particular the longitudinal edges of the separator, form the terminal sides or end faces of the electrode-separator assembly.

c. The longitudinal edges or margins of the anode current collector and/or cathode current collector protruding from the terminal end faces of the winding or sides of the stack do not exceed 5000 μm, preferably not more than 3500 μm.

It is preferred that the immediately preceding features a. to c. are realized in combination with each other.

Particularly preferably, the edge or longitudinal edge of the anode current collector protrudes from the page of the stack or the end face of the winding no more than 2500 μm, especially preferably no more than 1500 μm. Particularly preferably, the edge or longitudinal edge of the cathode current collector protrudes from the page of the stack or the end face of the winding no more than 3500 μm, especially preferably no more than 2500 μm.

The figures for the projection of the anode current collector and/or the cathode current collector refer to the free projection before the pages or end faces are brought into contact with the contact sheet metal member(s). When welding the contact sheet metal member or contact sheet metal members, deformation of the edges of the current collectors may occur.

The smaller the free projection is selected, the wider the preferably strip-shaped main regions of the current collectors covered with electrode material can be formed. This can contribute positively to the energy density of the cell.

The lithium-ion cell may be a button cell. Button cells are cylindrical in shape and have a height that is less than their diameter. Preferably, the height is in the range of 4 mm to 15 mm. It is further preferred that the button cell has a diameter in the range from 5 mm to 25 mm. Button cells are suitable, for example, for supplying electrical energy to small electronic devices such as watches, hearing aids and wireless headphones.

The nominal capacity of a lithium-ion cell according to the disclosure in the form of a button cell is generally up to 1500 mAh. Preferably, the nominal capacity is in the range from 100 mAh to 1000 mAh, preferably in the range from 100 to 800 mAh.

Particularly preferably, the lithium-ion cell according to the disclosure is a cylindrical round cell. Cylindrical round cells have a height that is greater than their diameter. They are particularly suitable for applications in the automotive sector, for e-bikes or also for other applications with high energy requirements.

Preferably, the height of lithium-ion cells designed as round cells is in the range of 15 mm to 150 mm. The diameter of the cylindrical round cells is preferably in the range of 10 mm to 60 mm. Within these ranges, form factors of, for example, 18×65 (diameter*height in mm) or 21×70 (diameter*height in mm) are preferred. Cylindrical round cells with these form factors are particularly suitable for supplying power to electric drives in motor vehicles.

The nominal capacity of the lithium-ion cell according to the disclosure, which is designed as a cylindrical round cell, is preferably up to 90000 mAh. With the form factor of 21×70, the cell in one embodiment as a lithium-ion cell preferably has a nominal capacity in the range from 1500 mAh to 7000 mAh, preferably in the range from 3000 to 5500 mAh. With the form factor of 18×65, the cell in one embodiment as a lithium-ion cell preferably has a nominal capacity in the range of 1000 mAh to 5000 mAh, preferably in the range of 2000 to 4000 mAh.

In the European Union, manufacturers are strictly regulated in providing information on the nominal capacities of secondary batteries. For example, information on the nominal capacity of secondary nickel-cadmium batteries must be based on measurements according to the IEC/EN 61951-1 and IEC/EN 60622 standards, information on the nominal capacity of secondary nickel-metal hydride batteries must be based on measurements according to the IEC/EN 61951-2 standard, information on the nominal capacity of secondary lithium batteries must be based on measurements according to the IEC/EN 61960 standard, and information on the nominal capacity of secondary lead-acid batteries must be based on measurements according to the IEC/EN 61056-1 standard. Any information on nominal capacities in the present application is preferably also based on these standards.

The anode current collector, the cathode current collector and the separator are preferably ribbon-shaped in embodiments in which the cell is a cylindrical round cell and preferably have the following dimensions:
A length in the range from 0.5 m to 25 m
A width in the range 30 mm to 145 mm

In these cases, the free edge strip extending along the first longitudinal edge, which is not loaded with the electrode material, preferably has a width of no more than 5000 μm.

In the case of a cylindrical round cell with the form factor 18×65, the current collectors preferably have
A width of 56 mm to 62 mm, preferably 60 mm, and
A length of not more than 1.5 m.

In the case of a cylindrical round cell with the form factor 21×70, the current collectors preferably have
A width of 56 mm to 68 mm, preferably 65 mm, and
A length of not more than 2.5 m.

The function of a lithium-ion cell is based on the availability of sufficient mobile lithium ions (mobile lithium) to balance the drawn off electric current by migration between the anode and the cathode or the negative electrode and the positive electrode. By mobile lithium in the context of this application is to be understood that the lithium is available for storage and removal processes in the electrodes in the course of the discharge and charge processes of the lithium-ion cell or can be activated for this purpose. In the course of the discharge and charge processes of a lithium-ion cell, losses of mobile lithium occur over time. These losses occur as a result of various, generally unavoidable side reactions. Losses of mobile lithium already occur during the first charge and discharge cycle of a lithium-ion cell. During this first charge and discharge cycle, a top layer generally forms on the surface of the electrochemically active components on the negative electrode. This top layer is called the Solid Electrolyte Interphase (SEI) and generally consists of mainly electrolyte decomposition products as well as a certain amount of lithium, which is firmly bound in this layer.

The loss of mobile lithium associated with this process is particularly severe in cells whose anode has portions of silicon. In order to compensate for these losses, the cell in preferred embodiments has at least one of the following features immediately a. and b.:

a. The cell comprises a depot of lithium or a lithium-containing material not comprised by the positive and/or negative electrode, which can be used to compensate for losses of mobile lithium in the cell during its operation.

b. The depot is in contact with the electrolyte of the cell.

c. The cell has an electrical conductor and, if necessary, also a controllable switch via which the depot can be electrically connected to the positive or negative electrode.

It is preferred that the immediately preceding features a. to c. are realized in combination with each other.

Particularly preferably, the depot is arranged inside the housing of the cell and the electrical conductor is led out of the housing, for example via a suitable pole bushing, in particular up to an electrical contact which can be drawn off from outside the housing.

The electrically contactable lithium depot makes it possible to supply lithium to the electrodes of the cell as required or to discharge excess lithium from the electrodes to prevent lithium plating. For this purpose, the lithium depot can be connected via the electrical conductor against the negative or against the positive electrode of the lithium-ion cell. Excess lithium can be fed to the lithium depot and deposited there if required. For these applications, means can be provided that allow separate monitoring of the individual potentials of the anode and cathode in the cell and/or external monitoring of the cell balance via electrochemical analyses such as DVA (differential voltage analysis).

The electrical conductor and the associated lithium depot must be electrically insulated from the positive and negative electrodes and any electrically coupled components of the cell.

The lithium or lithium-containing material of the lithium depot may be, for example, metallic lithium, a lithium metal oxide, a lithium metal phosphate, or other materials familiar to the skilled person.

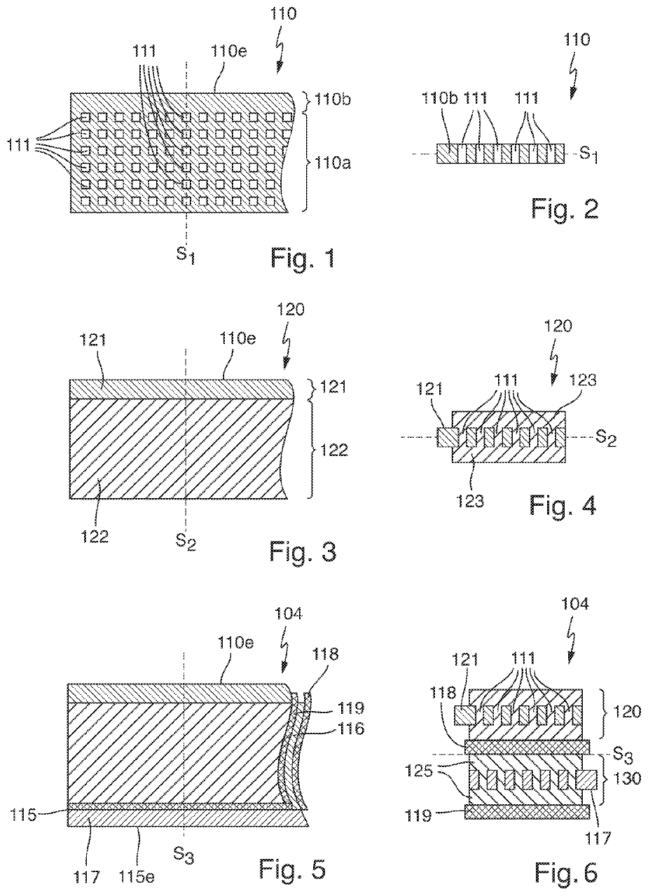

FIG. 1 and FIG. 2 illustrate the design of a current collector 110 that can be used in a cell. FIG. 2 is a sectional view along S₁. The current collector 110 comprises a plurality of apertures 111, which are rectangular holes. The region 110a is characterized by the apertures 111, whereas no apertures are found in the region 110b along the longitudinal edge 110e. Therefore, the current collector 110 has a significantly lower weight per unit area in the area 110a than in the area 110b.

FIG. 3 and FIG. 4 illustrate an anode 120 fabricated by applying a negative electrode material 123 to both sides of the current collector 110 shown in FIG. 2 and FIG. 3. FIG. 5 is a sectional view along S₂. The current collector 110 now has a strip-shaped main region 122 loaded with a layer of the negative electrode material 123, and a free edge strip 121 extending along the longitudinal edge 110e which is not loaded with the electrode material 123. Furthermore, the electrode material 123 also fills the apertures 111.

FIG. 5 and FIG. 6 illustrate an electrode-separator assembly 104 fabricated using the anode 120 shown in FIG. 4 and FIG. 5. In addition, it comprises the cathode 115 and the separators 118 and 119. FIG. 6 is a sectional view along S₃. The cathode 115 builds on the same current collector design as the anode 120. Preferably, the current collectors 110 and 115 of anode 120 and cathode 130 differ only in their respective material choices. For example, the current collector 115 of cathode 130 comprises a strip-shaped main region 116 loaded with a layer of positive electrode material 125, and a free edge strip 117 extending along longitudinal edge 115e that is not loaded with electrode material 125. By spirally winding, the electrode-separator assembly 104 can be transformed into a winding such as may be included in a cell.

In some preferred embodiments, the free edge strips 117 and 121 are coated on both sides and at least in some areas with one of the support materials described above.

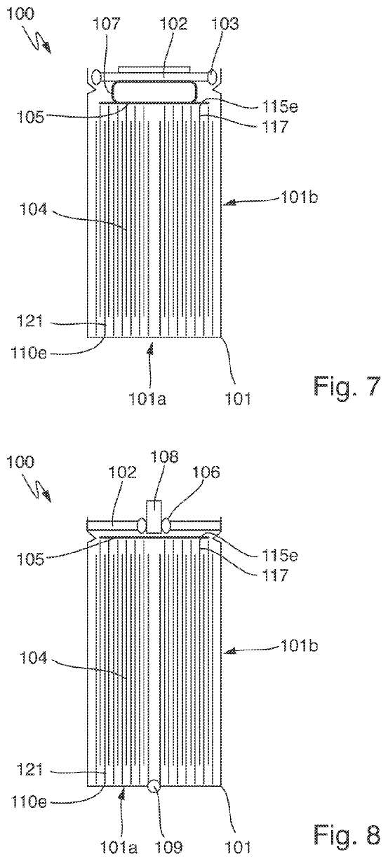

FIG. 7 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic housing, a section through the cell could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the plate-shaped contact sheet metal member 105 over its entire length and is connected thereto by welding over at least several sections, preferably over its entire length.

In turn, the contact sheet metal member 105 is electrically connected to the housing part 102 via the electrical conductor 107.

Preferably, there is a welded connection between the conductor 107 and the contact sheet metal member 105 on one page and the conductor 107 and the housing part 102 on the other page, respectively.

For an improved overview, no other components of the electrode-separator assembly 104 (especially separators and electrode materials) are shown—apart from the current collectors 110 and 115.

The housing parts 101 and 102 are electrically insulated from each other by the seal 103. The housing is closed, for example, by flanging. The housing part 101 forms the negative pole and the housing part 102 the positive pole of the cell 100.

FIG. 8 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic housing, a section through the cell could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the contact sheet metal member 105 over its entire length and is connected thereto by welding over at least several sections, preferably over its entire length.

The contact sheet metal member 105 is directly connected, preferably welded, to the metallic pole stud 108. This is led out of the housing through an aperture in the housing part 102 and insulated from the housing part 102 by means of the electrical insulation 106. The pole stud 108 and the electrical insulation 106 together form a pole bushing.

For an improved overview, no other components of the electrode-separator assembly 104 (in particular separators and electrode materials) are shown here either—apart from the current collectors 110 and 115.

In the bottom 101a there is a hole 109 closed, for example, by means of soldering, welding or bonding, which can be used, for example, to introduce electrolyte into the housing. Alternatively, a hole could have been made in the housing part 102 for the same purpose.

The housing part 102 is welded into the circular opening of the housing part 101. The housing parts 101 and 102 thus have the same polarity and form the negative pole of the cell 100. The pole stud 108 forms the positive pole of the cell 100.

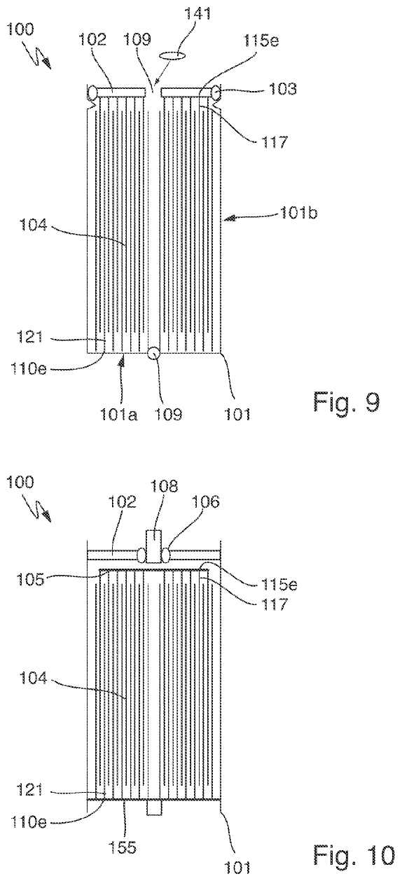

FIG. 9 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic housing, a section through the cell could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length. The edge 115e of the cathode current collector 115 is in direct contact with the housing part 102 over its entire length and is connected thereto by welding over at least several sections, preferably over its entire length.

For an improved overview, no other components of the electrode-separator assembly 104 (in particular separators and electrode materials) are shown here either—apart from the current collectors 110 and 115.

A hole 109 closed, for example by means of soldering, welding or bonding, is found in the bottom 101a, which can serve, for example, to introduce electrolyte into the housing. Another hole 109, which can serve the same purpose, is found here in the housing part 102. Preferably, this is closed by the pressure relief valve 141, which can be welded onto the housing part 102, for example.

The holes 109 shown are generally not both needed. In many cases, therefore, the cell 100 shown in FIG. 9 has only one of the two holes.

The housing parts 101 and 102 are electrically insulated from each other by the seal 103. The housing is closed, for example, by flanging. The housing part 101 forms the negative pole and the housing part 102 the positive pole of the cell 100.

FIG. 10 illustrates a cell 100 having a housing comprising a first housing part 101 and a second housing part 102 and a third housing part 155. The electrode-separator assembly 104 is enclosed in the housing. The housing has an overall cylindrical shape, the housing part 101 being formed here as a hollow cylinder with two end face circular openings. The housing parts 102 and 155 serve to close the circular openings and are formed as circular lids. The electrode-separator assembly 104 is in the form of a cylindrical winding with two terminal end faces.

In the case of prismatic housings, a section through the cell could look exactly the same. In this case, the housing part 101 would have a rectangular cross-section and two rectangular openings, and the housing parts 102 and 155 would be rectangular lids to close the rectangular openings. And the reference number 104 in this case would not denote an electrode-separator assembly in cylindrical form but a stack of several identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the housing part 155 over its entire length and is connected thereto by welding over at least several sections, preferably over its entire length. The housing part 155 thus also functions as a contact sheet metal member or contact plate. The edge 115e of the cathode current collector 115 is in direct contact with the contact sheet metal member 105 over its entire length and is connected thereto at least over several sections, preferably over its entire length, by welding.

For an improved overview, no other components of the electrode-separator assembly 104 (in particular separators and electrode materials) are shown here either—apart from the current collectors 110 and 115.

The contact sheet metal member 105 is directly connected, preferably welded, to the metallic pole stud 108. This is led out of the housing through an aperture in the housing part 102 and insulated from the housing part 102 by means of the electrical insulation 106. The pole stud 108 and the electrical insulation 106 together form a pole bushing.

In the housing part 102 there is a hole 109 closed, for example, by means of soldering, welding or bonding, which can be used, for example, to introduce electrolyte into the housing. Alternatively, a hole could have been made in the housing part 155 for the same purpose.

The housing parts 102 and 155 are welded into the circular openings of the housing part 101. The housing parts 101, 102 and 155 thus have the same polarity and form the negative pole of the cell 100. The pole stud 108 forms the positive pole of the cell 100.

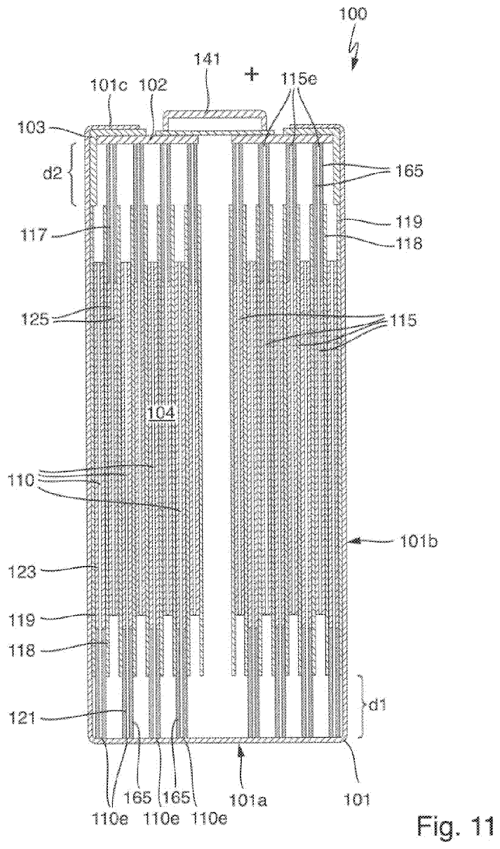

FIG. 11 illustrates a cell 100 having a housing comprising a first housing part 101 and a second housing part 102. Enclosed within the housing is the electrode-separator assembly 104. The housing is generally cylindrical in shape, and the housing part 101 has a circular bottom 101a, a hollow cylindrical shell 101b, and a circular opening opposite the bottom 101a. The housing part 102 serves to close the circular opening and is formed as a circular lid. The electrode-separator assembly 104 is in the form of a cylindrical winding having two terminal end faces.

In the case of prismatic housing, a section through the cell could look exactly the same. In this case, the housing part 101 would have a rectangular bottom 101a, a rectangular side wall 101b and a rectangular cross-section, and a rectangular opening, and the housing part 102 would be formed as a rectangular lid to close the rectangular opening. And the reference number 104 in this case would not denote an electrode-separator assembly in a cylindrical shape but a stack of a plurality of identical electrode-separator assemblies or a prismatic winding.

The free edge strip 121 of an anode current collector 110 protrudes from one end face of the electrode-separator assembly 104, and the free edge strip 117 of a cathode current collector 115 protrudes from the other end face. The edge 110e of the anode current collector 110 is in direct contact with the bottom 101a of the housing part 101 over its entire length and is connected thereto by welding over at least several sections, preferably over its entire length.

The edge 115e of the cathode current collector 115 is in direct contact with the housing part 102 over its entire length and is connected thereto by welding over at least several sections, preferably over its entire length. The housing part 102 thus serves here simultaneously as a contact sheet metal member or contact plate.

The anode current collector 110 is loaded on both sides with a layer of negative electrode material 123, but has a free edge strip 121 extending along the longitudinal edge 110e that is not loaded with the electrode material 123. Instead, the free edge strip 121 is coated on both sides with a ceramic support material 165.

The cathode current collector 115 is loaded on both sides with a layer of negative electrode material 125, but has a free edge strip 117 extending along the longitudinal edge 115e that is not loaded with the electrode material 125. Instead, the free edge strip 117 is coated on both sides with a ceramic support material 165.

The electrode-separator assembly 104 has two end faces formed by the longitudinal edges 118a and 119a and 118b and 119b of the separators 118 and 119. The longitudinal edges of the current collectors 110 and 115 protrude from these end faces. The corresponding protrusions are labelled d1 and d2.

A hole 109 is found in the housing part 102, which can be used, for example, to introduce electrolyte into the housing. The hole is closed by the pressure relief valve 141, which is connected to the housing part 102, for example, by welding.

The housing parts 101 and 102 are electrically insulated from each other by the seal 103. The housing is closed by flanging. For this purpose, the opening edge 101c of the housing part is bent radially inwards. The housing part 101 forms the negative pole and the housing part 102 the positive pole of the cell 100.

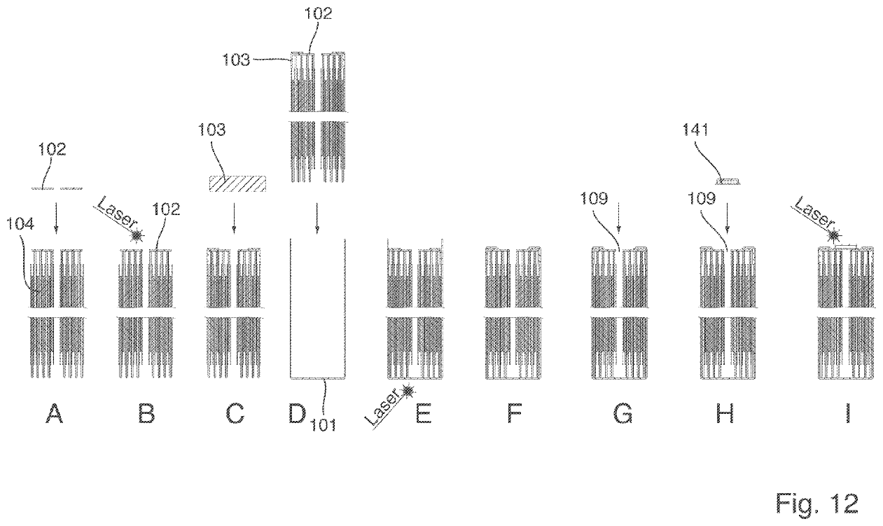

The cell shown in FIG. 11 can be manufactured according to FIG. 12, and the individual process steps A to I are described below. First, the electrode-separator assembly 104 is provided, on the upper end face of which the housing part 102 serving as contact sheet metal member or contact plate is placed. This is welded in step B to the longitudinal edge 115e of the cathode current collector 115. In step C, the circumferential seal 103 is applied to the edge of the housing part 102. With this, in step D, the electrode-separator assembly 104 is inserted into the housing part 101 until the longitudinal edge 110e of the anode current collector 110 is in direct contact with the bottom 101a of the housing part 101. In step E, this is welded to the bottom 101a of the housing part 101. In step F, the housing is closed by flanging. For this purpose, the opening edge 101c of the housing part 101 is bent radially inwards. In step G, the housing is filled with electrolyte, which is metered into the housing through the opening 109. The opening 109 is closed in steps H and I by means of the pressure relief valve 141, which is welded onto the housing part 102.

For example, the electrode-separator assembly 104 may comprise a positive electrode of 95 wt.-% NMCA, 2 wt.-% of an electrode binder, and 3 wt.-% carbon black as a conductive agent. The negative electrode can comprise a porous, electrically conductive matrix with an open pore structure.

For example, the electrode-separator assembly 104 may comprise a positive electrode of 95 wt.-% NMCA, 2 wt.-% of an electrode binder, and 3 wt.-% carbon black as a conductive agent, and a negative electrode of 70 wt.-% silicon, 25 wt.-% graphite, 2 wt.-% of an electrode binder, and 3 wt.-% carbon black as a conductive agent. A 2 M solution of LiPF₆ in THF/mTHF (1:1) or a 1.5 M solution of LiPF₆ in FEC/EMC (3:7) with 2 wt.-% VC can be used as the electrolyte.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A lithium ion cell, comprising:
a ribbon-shaped electrode-separator assembly comprising an anode, a separator, and a cathode in a sequence anode/separator/cathode, wherein:
the anode comprises a ribbon-shaped anode current collector having a first longitudinal edge, a second longitudinal edge, and two ends,
wherein the anode current collector has a strip-shaped main region loaded with a layer of negative electrode material and a free edge strip extending along the first longitudinal edge that is not loaded with the electrode material, and
the cathode comprises a ribbon-shaped cathode current collector having a first longitudinal edge, a second longitudinal edge, and two ends,
wherein the cathode current collector has a strip-shaped main region loaded with a layer of positive electrode material and a free edge strip extending along the first longitudinal edge that is not loaded with the electrode material;
a housing that encloses the electrode-separator assembly; and
a contact sheet metal member in direct contact with a first respective longitudinal edge, the first respective longitudinal edge being the first longitudinal edge of the anode current collector or the first longitudinal edge of the cathode current collector, wherein the contact sheet metal member is connected to the first respective longitudinal edge by welding;
wherein the electrode-separator assembly is in the form of: a winding comprising two terminal end faces or a stack comprising two or more electrode-separator sub-assemblies, the stack comprising two end sides,
wherein the anode and the cathode are formed and/or arranged relative to each other within the electrode-separator assembly such that the first longitudinal edge of the anode current collector protrudes from one of the terminal end faces of the winding or one of the end sides of the stack and the first longitudinal edge of the cathode current collector protrudes from another one of the terminal end faces of the winding or another one of the end sides of the stack, and
wherein the negative electrode material comprises at least one active material comprising at least one of silicon, aluminum, tin, antimony, and/or a compound or alloy thereof capable of reversibly incorporating and releasing lithium, the negative electrode material containing the at least one active material in a range of from 20 wt % to 90 wt %.

2. The cell according to claim 1, wherein the negative electrode material further comprises, as a negative active material, carbon-based particles capable of reversible lithium insertion and removal, the negative electrode material containing the negative active material in a range of 5 wt. % to 75 wt. %.

3. The cell according to claim 1, wherein at least one of:
the negative electrode material comprises an electrode binder and/or a conductive agent,
the negative electrode material contains the electrode binder in a range of 1 wt. % to 15 wt. %, and/or
the negative electrode material contains the conductive agent in a range of 0.1 wt. % to 15 wt. %.

4. The cell according to claim 1, wherein at least one of:
the positive electrode material comprises a metal oxide compound capable of reversible lithium deposition and removal,
the metal oxide compound capable of reversible lithium deposition and removal is at least one oxide cobalt and/or manganese compound, the positive electrode material containing the at least one oxide cobalt and/or manganese compound in a range of from 80 wt % to 99 wt %,
the positive electrode material comprises an electrode binder and/or a conductive agent,
the positive electrode material contains the electrode binder in a range of 1 wt. % to 15 wt. %, and/or
the positive electrode material contains the conductive agent in a proportion of 0.1 wt. % to 15 wt. %.

5. The cell according to claim 1, wherein a weight per unit area of the negative electrode deviates from a mean value by a maximum of 2-% per unit area of at least 10 cm².

6. The cell according to claim 1, further comprising:
an electrolyte comprising a mixture of tetrahydrofuran (THF) and 2-methyltetrahydrofuran (mTHF) and/or an electrolyte comprising LiPF₆ as a conducting salt.

7. The cell according to claim 1, further comprising at least one of:
an electrolyte comprising a mixture of fluoroethylene carbonate (FEC) and ethyl methyl carbonate (EMC);
an electrolyte comprising LiPF₆ as a conducting salt, and/or
an electrolyte comprising vinylene carbonate.

8. The cell according to claim 1, wherein at least one of:
a respective strip-shaped main region has a plurality of apertures, the respective strip-shaped main region being the strip-shaped main region of the anode current collector or the strip-shaped main region of the cathode current collector,
the apertures in the main area are round or square holes, and/or
a respective strip-shaped main region is perforated by round hole or slotted hole perforation, the respective strip-shaped main region being the strip-shaped main region of the anode current collector or the strip-shaped main region of the cathode current collector.

9. The cell according to claim 8, wherein the apertures have an average diameter in a range of 1 μm to 2000 μm.

10. The cell according to claim 1, wherein at least one of:
a respective first current collector, the respective first current collector comprising the first respective longitudinal edge, has a total weight per unit area lower than a weight per unit area of the free edge strip of the respective first current collector, and/or
a respective first current collector, the respective first current collector comprising the first longitudinal edge, has no or apertures in the free edge strip thereof or has fewer apertures per unit area in the free edge strip thereof than in the main area thereof.

11. The cell according to claim 1, wherein a first respective current collector is the anode current collector or the cathode current collector, and wherein at least one of:
a weight per unit area of the first respective current collector in a main area thereof is reduced by 5% to 80% compared to a weight per unit area of the first respective current collector in the free edge strip thereof,
the first respective current collector has a hole area in a range of 5% to 80% in the main area thereof, and/or
the first respective current collector has a tensile strength of 20 N/mm² to 250 N/mm² in the main area thereof.

12. The cell according to claim 2, wherein the negative active material is graphitic carbon and/or are a mixture of silicon and the carbon-based particles.

13. The cell according to claim 2, wherein the negative electrode material contains the carbon-based particles in a range of 15 wt. % to 45 wt. %.

14. The cell according to claim 4, wherein the metal oxide compound capable of reversible lithium deposition and removal is one of nickel manganese cobalt oxide (NMC), nickel cobalt alumina (NCA) or nickel manganese cobalt alumina (NMCA).

15. The cell according to claim 6, wherein a volume ratio of THE to mTHF in the mixture is in a range of 2:1 to 1:2, and/or
wherein the conducting salt contained in the electrolyte at a concentration of 1.5 to 2.5 M.

16. The cell according to claim 7, wherein at least one of:
a volume ratio of FEC:EMC in the mixture is in a range of 1:7 to 5:7,
the conducting salt is contained in the electrolyte at a concentration of 1.0 to 2.0 M, and/or
the vinylene carbonate is contained in the electrolyte in a range of 1% to 3% by weight.
